(19) United States
(12) Patent Application Publication
(10) Pub. No.: US 2013/0244754 A1
(43) Pub. Date: Sep. 19, 2013

(54) METHOD OF GAMING, A GAME CONTROLLER AND A GAMING SYSTEM

(71) Applicant: ARISTOCRAT TECHNOLOGIES AUSTRALIA PTY LIMITED, North Ryde (AU)

(72) Inventors: Edgar Pau, Newington (AU); Matthew Chan, East Killara (AU)

(73) Assignee: Aristocrat Technologies Australia PTY Limited, North Ryde (AU)

(21) Appl. No.: 13/889,159

(22) Filed: May 7, 2013

Related U.S. Application Data
(63) Continuation of application No. 12/777,016, filed on May 10, 2010, now abandoned.

(30) Foreign Application Priority Data
May 11, 2009 (AU) 2009902076

(51) Int. Cl. G07F 17/34

(52) U.S. Cl. CPC G07F 17/34
USPC 463/20

(57) ABSTRACT

A method of gaming including initiating a sequence of at least two outcomes, determining any current end condition to apply to the current outcome in the sequence from at least the previous outcome in the sequence, wherein each outcome is derived from a selection of one of a plurality of objects presented to a player at respective ones of a plurality of display positions on a display of a gaming system, and ending the sequence upon the current end condition being met by the current outcome.

### CROSS-REFERENCE TO RELATED APPLICATIONS

The present application relates to and claims the benefit of priority to U.S. patent application Ser. No. 12/777,016, filed on May 10, 2010, entitled “A METHOD OF GAMING, A GAME CONTROLLER AND A GAMING SYSTEM”, which claims the benefit of priority to Australian Provisional Patent Application Number 2009902076, filed on May 11, 2009, each of which is herein incorporated by reference in its entirety.

### FIELD

The invention relates to a method of gaming, a game controller and a gaming system.

### BACKGROUND

There are gaming systems which involve a player making one or more selections of a plurality of objects displayed to the player on a display. While such gaming systems provide players with enjoyment, a need exists for alternative gaming systems in order to maintain or increase player enjoyment.

### SUMMARY

In a first aspect, the invention provides a method of gaming including:

initiating a sequence of at least two outcomes;

determining any current end condition to apply to the current outcome in the sequence from at least the previous outcome in the sequence, wherein each outcome is derived from a selection of one of a plurality of objects presented to a player at respective ones of a plurality of display positions on a display of a gaming system; and

ending the sequence upon the current end condition being met by the current outcome.

In an embodiment, each object is pre-associated with an outcome and the outcome is revealed when the object is selected.

In an embodiment, the method includes receiving the selection from the player.

In an embodiment, the current end condition is derived from the previous outcome in the sequence.

In an embodiment, the current end condition is derived from all of the previous outcomes in the sequence.

In an embodiment, at least one previous outcome results in no end condition applying to the current outcome.

In an embodiment, each outcome is a number of a set of numbers and the end condition is that the number of the current outcome is lower than the previous number.

In an embodiment, each outcome is a number of a set of numbers and the end condition is that the number of the current outcome has been selected in a previous outcome.

In an embodiment, a player has a number of chances and the end condition includes that the player is on their last chance.

In an embodiment, the method includes accumulating each outcome in a pool.

In an embodiment, the method includes making an award based on the value of the pool.

In a second aspect, the invention provides a game controller for a gaming system, the game controller arranged to:

initiate a sequence of at least two outcomes;

determine any current end condition to apply to the current outcome in the sequence from at least the previous outcome in the sequence, wherein each outcome is derived from a selection of one of a plurality of objects presented to a player at respective ones of a plurality of display positions; and

end the sequence upon the current end condition being met by the current outcome.

In an embodiment, the game controller includes an end condition controller arranged to determine the current end condition.

In an embodiment, the game controller includes a sequence ender arranged to end the sequence.

In an embodiment, the game controller is implemented by a processor executing program code stored in a memory.

In an embodiment, each object is pre-associated with an outcome and the outcome is revealed when the object is selected.

In an embodiment, the current end condition is derived from the previous outcome in the sequence.

In an embodiment, the current end condition is derived from all of the previous outcomes in the sequence.

In an embodiment, at least one previous outcome results in no end condition applying to the current outcome.

In an embodiment, each outcome is a number of a set of numbers and the end condition is that the number of the current outcome is lower than the previous number.

In an embodiment, each outcome is a number of a set of numbers and the end condition is that the number of the current outcome has been selected in a previous outcome.

In an embodiment, a player has a number of chances and the end condition includes that the player is on their last chance.

In an embodiment, the game controller is arranged to accumulate each outcome in a pool.

In an embodiment, the game controller is arranged to make an award based on the value of the pool.

In a third aspect, the invention provides a gaming system including:

a display for displaying outcomes; and

a game controller arranged to:

initiate a sequence of at least two outcomes displayed on the display; determine any current end condition to apply to the current outcome in the sequence from at least the previous outcome in the sequence, wherein each outcome is derived from a selection of one of a plurality of objects presented to a player at respective ones of a plurality of display positions; and

end the sequence upon the current end condition being met by the current outcome.

In an embodiment, each object is pre-associated with an outcome and the outcome is revealed when the object is selected.

In an embodiment, the current end condition is derived by the game controller from the previous outcome in the sequence.

In an embodiment, the current end condition is derived by the game controller from all of the previous outcomes in the sequence.

In an embodiment, at least one previous outcome results in no end condition applying to the current outcome.

In an embodiment, each outcome is a number of a set of numbers and the end condition is that the number of the current outcome is lower than the previous number.

In an embodiment, each outcome is a number of a set of numbers and the end condition is that the number of the current outcome has been selected in a previous outcome.

In an embodiment, a player has a number of chances and the end condition includes that the player is on their last chance.

In an embodiment, the game controller is arranged to accumulate each outcome in a pool.

In an embodiment, the game controller is arranged to make an award based on the value of the pool.

In a fourth aspect, the invention provides computer program code which when executed implements the above method.

In a fifth aspect, the invention provides a computer readable medium including the above program code.

In a sixth aspect, the invention extends to transmitting the above program code.

### BRIEF DESCRIPTION OF DRAWINGS

Certain exemplary embodiments of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system; and

FIG. 7 is a flow chart of an embodiment.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Referring to the drawings, there is shown a gaming system having a game controller arranged to implement a game involving a sequence of outcomes where the condition for ending the game is dynamic as any end condition which applies is determined from at least the previous outcome in the sequence.

### General Construction of Gaming System

The gaming system can take a number of different forms. In a first form, a stand alone gaming machine is provided wherein all or most components to implement the game are present in a player operable gaming machine.

In a second form, a distributed architecture is provided wherein some of the components to implement the game are present in a player operable gaming machine and some of the components to implement the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

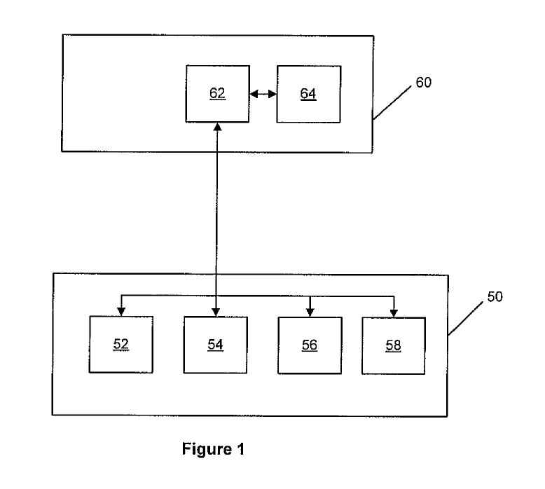

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place bets), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

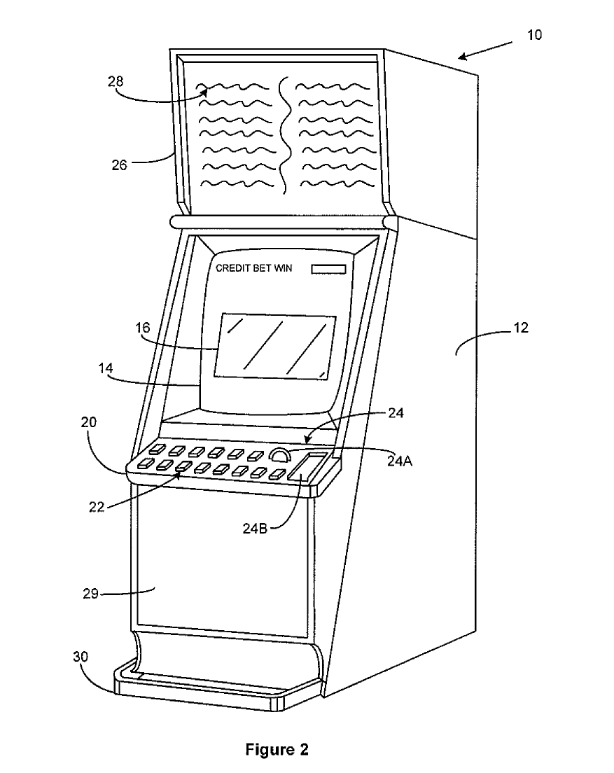

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

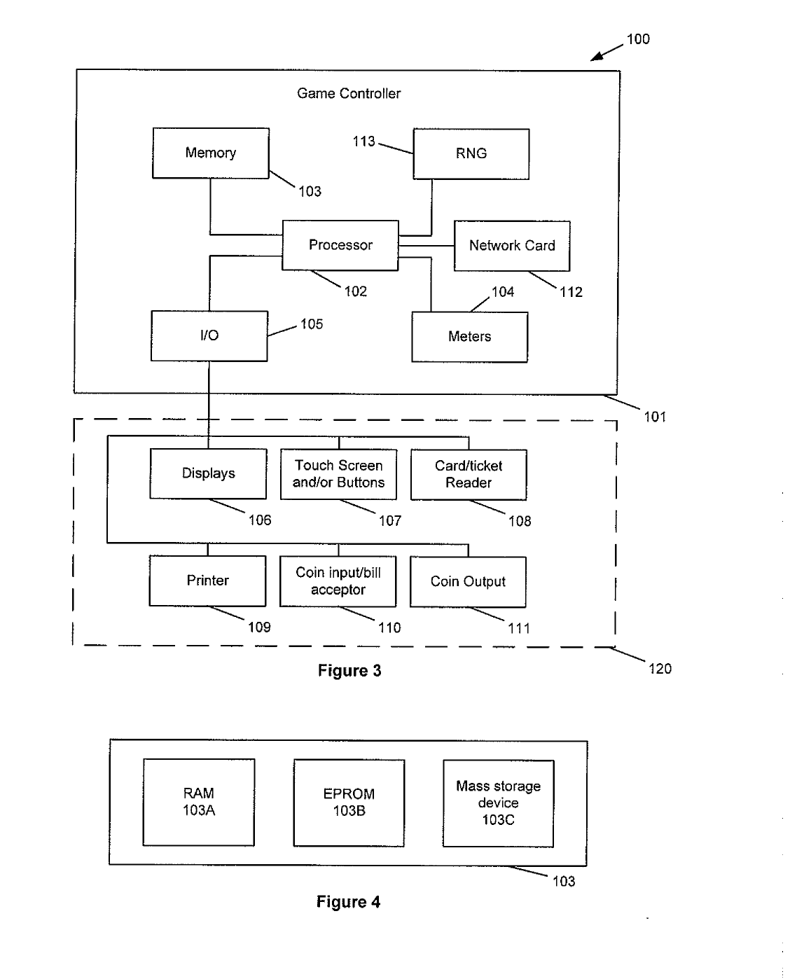

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation. For example, while buttons or touch screens are typically used in gaming machines to allow a player to place a wager and initiate a play of a game any input device that enables the player to input game play instructions may be used. For example, in some gaming machines a mechanical handle is uses to initiate a play of the game.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

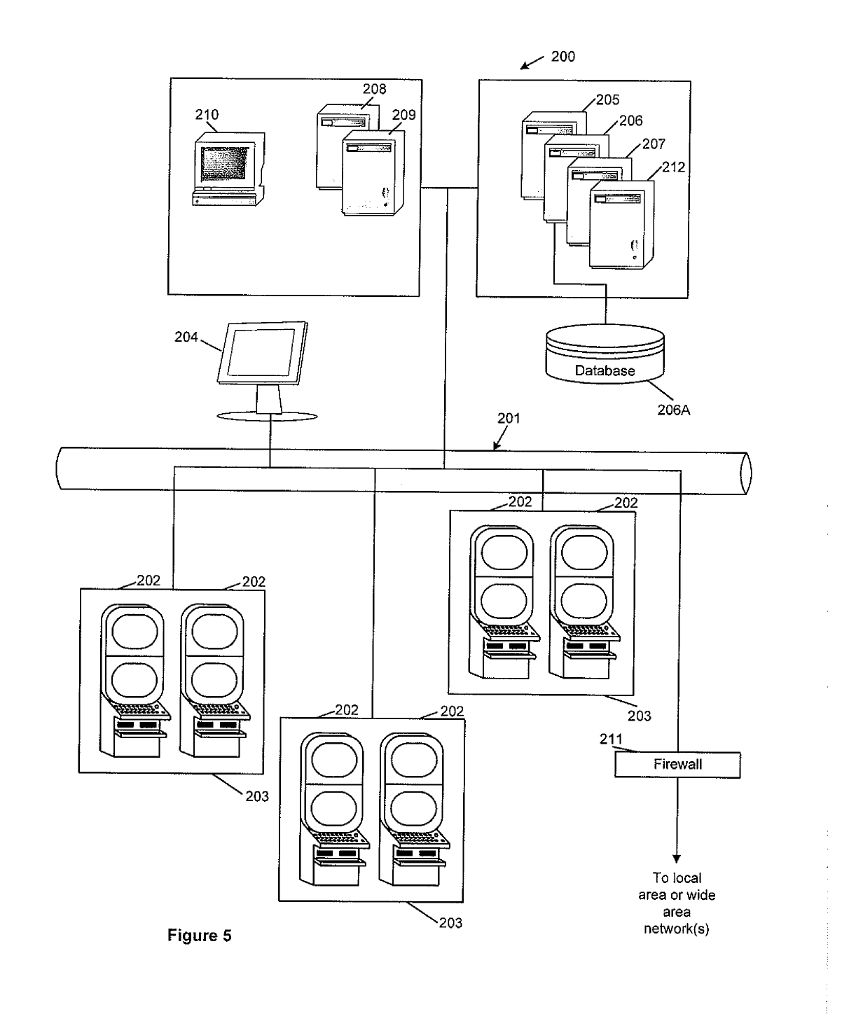

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the rules, requirements, guidelines, and/or preferences for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

### Further Detail of Gaming System

The gaming system shows a standalone implementation of the game, however persons skilled in the art will appreciate that the game could be offered as a bonus or feature game, triggered from another game such as a spinning reel or poker game in accordance with known triggering techniques. Accordingly, it will also be appreciated that the gaming system would incorporate other components in such an embodiment but that they are not shown here for clarity of exposition as are certain standard components such as credit meters etc.

To start a play of the game, the player establishes credit via credit mechanism 52. The player then operates the game play mechanism 56 to initiate a play of the game which will involve a sequence of outcomes. The object display generator 622 displays a set of N objects at N display positions by randomly selecting one of the N objects stored as object data 642 for display at each display position using random number generator 621. The generated object display is stored as object position data 643 and displayed on display 54 under control of display controller 626 which may incorporate an appropriate graphics driver for display 54.

In the embodiment, the display 54 is the display of a gaming machine, however, in other embodiments, the display 54 may be the display of a player marketing module mounted to the gaming machine, or a communal display over a group of gaming machines. Each object has a value and that value is not revealed until after selection as described in further detail below. The objects can be balls, cards, boxes etc

The value can be for example, a number, a colour, an image, a function (e.g. “wild”), an award (e.g. 10 free games) or combinations of those. Values can be ranked (as per the below examples), or be in a relationship to each other (e.g. stone, paper, scissors) or be in a relationship to each other relative to some set of rules (e.g. stone blunts scissors, paper rubs stone, scissors cut paper). Sets of rules are defined by the game designer as desired and are stored in memory 64 as rule data 622.

The number of objects N can be determined in any of a number of ways—e.g. fixed, related to player bet, related to a trigger condition which initiates the game (when the game is triggered), variable dependent upon time or machine condition etc.

In this embodiment, selections of the objects are made by the player by touching the touch screen 56A of game play mechanism 56 at a position corresponding to where the objects are displayed on the display 54. In other embodiments, selection may be made: by a group of players (in a community game); automatically (this may also be the standard process when there is a time out); or as an outcome of another game (e.g. an outcome on a reel spin)

Once a selection is made, the selection is processed by the selection processor 623 and the value of the object is revealed based on the object position data 643. The value of the object is the first outcome in the sequence of outcomes and is accumulated in a pool 644. In the embodiment, the pool 644 is an individual player pool. In other embodiments, the pool may be a community pool which can be awarded to one or more of the players playing the community game, or a charity pool (to be awarded to a charity).

In the embodiment, the first outcome results in the end condition determiner 624 determining the first end condition from the first outcome (in other embodiments, the rules some outcomes may not result in an end condition or may reset the end condition). The end condition is then displayed on display 54.

The second selection is made thereby generating a second outcome. If the second selection meets the end criteria, then the game concludes under control of the sequence ender 625. The value of the second outcome is added to the pool or not depending on game rules.

If the second selection does not meet the end criteria, then a new end criteria is determined by the end condition determiner 624, for example based on the current outcome or the current outcome and the previous outcomes and this end condition is applied to the subsequent selection. Play continues until the sequence ender 625 determines that the current end condition is met. When the current end condition is met, the award module 627 processes the current pool value stored in pool data 644 in conjunction with prize data 645 to determine whether to make an award to the player and the quantum of any award.

In a variation, the player may have more than one chance of not meeting a criteria (and hence the end condition may require more than one criteria to be met). For example, the player can continue until the current value is less than the previous value for the second time in the game.

In another variation, certain outcomes may not set an end condition. For example, player selects the object corresponding to the highest value, then the next outcome selected does not have to meet any criteria and they can continue selecting another object.

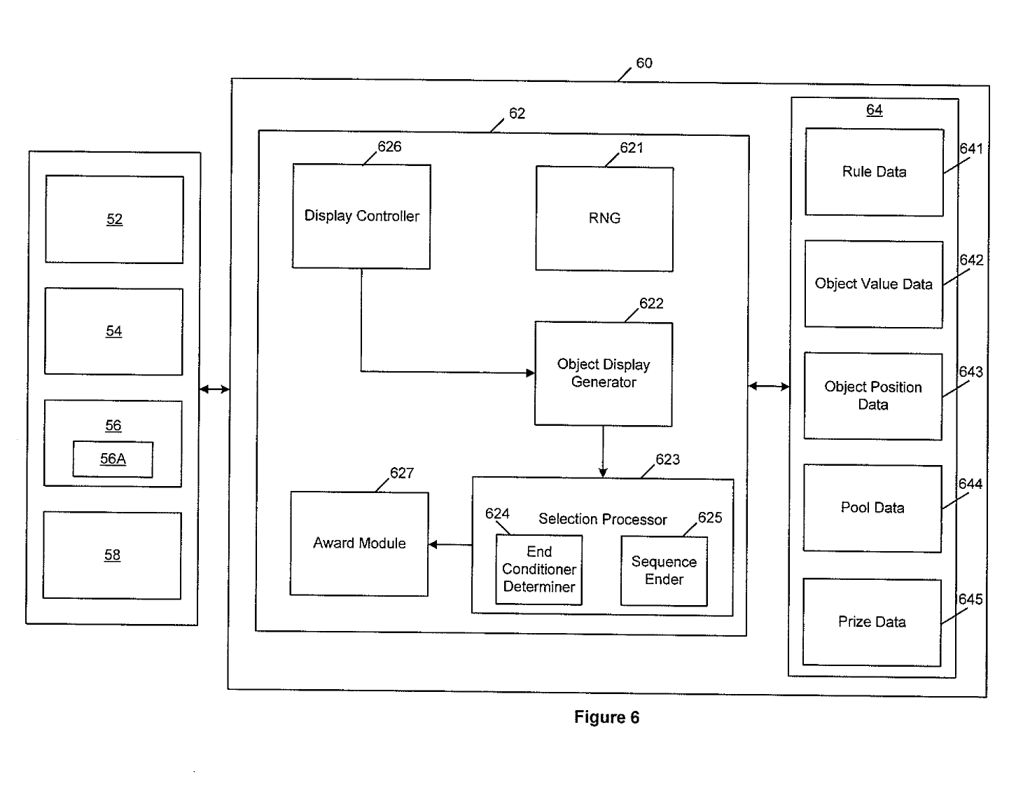

In FIG. 6, the processor 62 of game controller 60 is shown implementing a number of modules based on program code and data stored in memory 64. Persons skilled in the art will appreciate that various of the modules could be implemented in some other way, for example by a dedicated circuit.

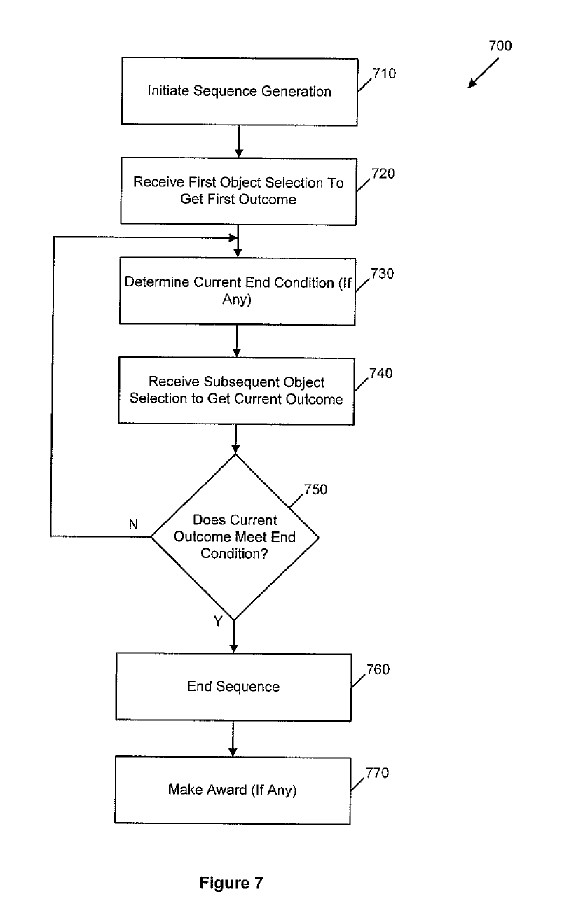

FIG. 7 depicts an example flow diagram representative of processes that may be implemented using, for example, computer readable instructions that may be used to facilitate game play. The example processes of FIG. 7 may be performed using a processor, a controller and/or any other suitable processing device. For example, the example processes of FIG. 7 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 7 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 7 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 7 may be implemented manually or as any combination(s) of any of the foregoing techniques, for example, any combination of firmware, software, discrete logic and/or hardware. Further, although the example processes of FIG. 7 are described with reference to the flow diagram of FIG. 7, other methods of implementing the processes of FIG. 7 may be employed. For example, the order of execution of the blocks may be changed, and/or some of the blocks described may be changed, eliminated, sub-divided, or combined. Additionally, any or all of the example processes of FIG. 7 may be performed sequentially and/or in parallel by, for example, separate processing threads, processors, devices, discrete logic, circuits, etc.

The method 700 of the embodiment is summarised in FIG. 7 and involves initiating 710 generation of a sequence of outcomes in response to imitation of play. A first selection is received 720 from which the first outcome is determined. It is then determined 730 if an end condition will apply and, if so, the nature or value of the end condition. A subsequent selection is received to obtain a current outcome 740 which is added to the pool and it is determined 750 whether the current outcome meets the current end condition. If not, the method repeats through steps 730,740,750. If the condition is met, the sequence is ended 760 and it is determined 770, whether to make an award and the value of that award based on the current value of the pool.

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory 103) or as a data signal (for example, by downloading it from a server).

### EXAMPLES

### Example 1

There are 25 objects in the form of balls displayed on the screen. The balls are numbered from 1 to 25 and are placed in a random order on display using random number generator 621. These numbers are hidden to the player until the player selects it and the number is then revealed.

The player makes his first selection. The number on the ball is revealed and added to the player's score. The player makes his next selection; the number on the ball is revealed and added to the player's score. If this number is higher than the previous number selected then the player can make another ball selection. This continues until the player selects a ball that reveals a number that is lower than the previous number revealed.

A specific example of play is as follows:
Player reveals 5, Pool=5.
Player reveals 10, Pool=5+10=15. Play continues as 10>5.
Player reveals 15, Pool=15+15=30. Play continues as 15>10.
Player reveals 18, Pool=30+18=48. Play continues as 18>15.
Player reveals 4, Pool=48+4=52. Play ends as 4<10.
The final pool value (or score) is 52. Prize is awarded according to this score.

### Example 2

There are 20 balls are on the screen. The balls are numbered from 1 to 10 (two balls of each number) and are in a random order. These numbers are hidden to the player until the player selects it and the number is then revealed.

The player makes his first selection. The number on the ball is revealed and added to the player's score. The player makes his next selection; the number on the ball is revealed and added to the player's score. If this number has not been revealed in any previous selection then the player can make another ball selection. This continues until the player selects a ball that reveals a number that is has already been revealed.

A specific example of play is as follows:
Player reveals 5, Pool=5. Play continues as 5 has not been revealed previously.
Player reveals 10, Pool=5+10=15 Play continues as 10 has not been revealed previously.
Player reveals 6, Pool=15+6=21. Play continues as 6 has not been revealed previously.
Player reveals 9 Pool=21+9=30. Play continues as 9 has not been revealed previously.
Player reveals 10, Pool=30+10=40. Play ends as 10 has been revealed previously.
The final score is Pool. Prize is awarded according to this score.

### Example 3

Selection 1—the object revealed is an axe. The end criteria is that the game ends if another axe is revealed and “axe” is added to pool.

Selection 2—the object revealed is a spade. The end criteria is that the game ends if another axe or spade is revealed and “spade” is added to pool.

Play continues until a duplicate object is selected. At end, the collection in the pool is compared to a prize schedule and awards are made. For example, based on the number of different objects, total number of object, or the number and type of objects.

### Example 4

Selection 1—the object revealed is a red number 2. The end criteria is game ends if another red number is revealed and the value of the pool is 2.

Selection 2—the object revealed is a blue number 10. The end criteria is game ends if a blue number is revealed next and the pool increases to 12.

Play continues until a ball duplicating the immediately prior colour occurs after which a prize is awarded based on the pool value.

### Example 5

This example is based on the game paper, rock, scissors. In that game stone blunts scissors, paper rubs stone, scissors cut paper.

Selection 1—the outcome is scissors which is added to the pool. The end condition is that the next outcome is paper. Accordingly play will continue for either stone or a further pair of scissors.

Selection 2—the outcome is paper and the sequence ends. Paper is added to the pool and the relevant prize is awarded.

In a variation on the above, the outcome which results in an end condition being met may not be added to the pool.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments and/or aspects without departing from the spirit or scope of the invention as broadly described. For example, it will be apparent that certain features of the invention can be combined to form further embodiments. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A method of gaming comprising:
initiating a sequence of at least two outcomes, wherein each outcome is derived from a selection of one of a plurality of objects presented to a player at respective ones of a plurality of display positions on a display of a gaming system, the plurality of objects including at least a first and at least a second object that is associated with the first object;
determining a current end condition to apply to the current outcome in the sequence from at least the previous outcome in the sequence, wherein when the player selects the first object from the plurality of objects, the current end condition is determined when the player selects the associated second object; and
ending the sequence upon the current end condition being met by the current outcome.

2. A method as claimed in claim 1, wherein each object is pre-associated with an outcome and the outcome is revealed when the object is selected.

3. A method as claimed in claim 1, comprising receiving the selection from the player.

4. A method as claimed in claim 1, wherein the current end condition is derived from the previous outcome in the sequence.

5. A method as claimed in claim 1, wherein the current end condition is derived from all of the previous outcomes in the sequence.

6. A method as claimed in claim 1, wherein at least one previous outcome results in no end condition applying to the current outcome.

7. A method as claimed in claim 4, wherein each outcome is a number of a set of numbers and the end condition is that the number of the current outcome is lower than the previous number.

6. A method as claimed in claim 5, wherein each outcome is a number of a set of numbers and the end condition is that the number of the current outcome has been selected in a previous outcome.

9. A method as claimed in claim in claim 1, wherein a player has a number of chances and the end condition includes that the player is on their last chance.

10. A method as claimed in claim 1, comprising accumulating each outcome in a pool.

11. A method as claimed in claim 10, comprising making an award based on the value of the pool.

12. A game controller for a gaming system, the game controller arranged to:
initiate a sequence of at least two outcomes, wherein each outcome is derived from a selection of one of a plurality of objects presented to a player at respective ones of a plurality of display positions on a display of a gaming system, the plurality of objects including at least a first and at least a second object that is associated with the first object;
determine a current end condition to apply to the current outcome in the sequence from at least the previous outcome in the sequence, wherein when the player selects the first object from the plurality of objects, the current end condition is determined when the player selects the associated second object; and
end the sequence upon the current end condition being met by the current outcome.

13. A game controller as claimed in claim 12, comprising an end condition controller arranged to determine the current end condition.

14. A game controller as claimed in claim 12, comprising a sequence ender arranged to end the sequence.

15. A game controller as claimed in claim 12, implemented by a processor executing program code stored in a memory.

16. A game controller as claimed in claim 12, wherein each object is pre-associated with an outcome and the outcome is revealed when the object is selected.

17. A game controller as claimed in claim 12, wherein the current end condition is derived from the previous outcome in the sequence.

18. A game controller as claimed in claim 12, wherein the current end condition is derived from all of the previous outcomes in the sequence.

19. A game controller as claimed in claim 12, wherein at least one previous outcome results in no end condition applying to the current outcome.

20. A game controller as claimed in claim 17, wherein each outcome is a number of a set of numbers and the end condition is that the number of the current outcome is lower than the previous number.

21. A game controller as claimed in claim 18, wherein each outcome is a number of a set of numbers and the end condition is that the number of the current outcome has been selected in a previous outcome.

22. A game controller as claimed in claim 12, wherein a player has a number of chances and the end condition includes that the player is on their last chance.

23. A game controller as claimed in claim 12, arranged to accumulate each outcome in a pool.

24. A game controller as claimed in claim 23, arranged to make an award based on the value of the pool.

25. A gaming system comprising:
a display for displaying outcomes; and
a game controller arranged to:
initiate a sequence of at least two outcomes displayed on the display, wherein each outcome is derived from a selection of one of a plurality of objects presented to a player at respective ones of a plurality of display positions on a display of a gaming system, the plurality of objects including at least a first and at least a second object that is associated with the first object;
determine a current end condition to apply to the current outcome in the sequence from at least the previous outcome in the sequence, wherein when the player selects the first object from the plurality of objects, the current end condition is determined when the player selects the associated second object; and
end the sequence upon the current end condition being met by the current outcome.

26. A gaming system as claimed in claim 25, wherein each object is pre-associated with an outcome and the outcome is revealed when the object is selected.

27. A gaming system as claimed in claim 25, wherein the current end condition is derived by the game controller from the previous outcome in the sequence.

28. A gaming system as claimed in claim 25, wherein the current end condition is derived by the game controller from all of the previous outcomes in the sequence.

29. A gaming system as claimed in claim 25, wherein at least one previous outcome results in no end condition applying to the current outcome.

30. A gaming system as claimed in claim 28, wherein each outcome is a number of a set of numbers and the end condition is that the number of the current outcome is lower than the previous number.

31. A gaming system as claimed in claim 29, wherein each outcome is a number of a set of numbers and the end condition is that the number of the current outcome has been selected in a previous outcome.

32. A gaming system as claimed in claim 25, wherein a player has a number of chances and the end condition includes that the player is on their last chance.

33. A gaming system as claimed in claim 25, wherein the game controller is arranged to accumulate each outcome in a pool.

34. A gaming system as claimed in claim 33, wherein the game controller is arranged to make an award based on the value of the pool.

35. A tangible computer readable medium comprising computer program code which, when executed, implements a method of gaming comprising:
initiating a sequence of at least two outcomes, wherein each outcome is derived from a selection of one of a plurality of objects presented to a player at respective ones of a plurality of display positions on a display of a gaming system, the plurality of objects including at least a first and at least a second object that is associated with the first object;
determining a current end condition to apply to the current outcome in the sequence from at least the previous outcome in the sequence, wherein when the player selects the first object from the plurality of objects, the current end condition is determined when the player selects the associated second object; and
ending the sequence upon the current end condition being met by the current outcome.
